(19) United States
(12) Patent Application Publication
(10) Pub. No.: US 2024/0009065 A1
(43) Pub. Date: Jan. 11, 2024

(54) EYE MOVEMENT DEVICE

(71) Applicant: Hee Joon YOUN, Bucheon-si (KR)

(72) Inventor: Hee Joon YOUN, Bucheon-si (KR)

(21) Appl. No.: 18/218,702

(22) Filed: Jul. 6, 2023

Related U.S. Application Data
(63) Continuation of application No. PCT/KR2021/018187, filed on Dec. 3, 2021.

(30) Foreign Application Priority Data
Jan. 6, 2021 (KR) 10-2021-0001168

(51) Int. Cl. A61H 5/00

(52) U.S. Cl. CPC A61H 5/00; A61H 2205/024

(57) ABSTRACT

The present invention relates to an apparatus for exercising an eyeball, in which a geared motor (20) is mounted on an upper end of a column (11) of a stand (10), an output shaft (21) of the geared motor (20) is inserted into a hole (31) formed at one end of a rotating arm (30), a connecting shaft (35) is mounted on a free end of the rotating arm (30) in parallel with the output shaft (21), the connecting shaft (35) is inserted into an upper horizontal shaft hole 41 of a balance weight (40) through a bearing (50), a magnet (60) is mounted on a front of the balance weight (40), and an iron plate (76) attached to a case 75 of a smartphone (70) is attached to the magnet (60).

### TECHNICAL FIELD

The present invention relates to an apparatus for exercising an eyeball, and more particularly, to an apparatus for exercising an eyeball that enables a user to exercise an eyeball while watching a screen of a smartphone rotating at a low speed by continuing to maintain the screen state of the smartphone attached to a magnet of a balance weight without changing the screen state of the smartphone attached to the magnet since the balance weight is mounted on a connecting shaft formed at a free end of an arm to enable relative rotation when a geared motor is mounted on an upper end of a column of a stand and the free end of the arm makes a circular motion at a low speed around an output shaft of the geared motor.

### BACKGROUND ART

Korean Patent No. 10-2075499 (registered on Feb. 4, 2020) introduces “Apparatus for exercising an eyeball.”

The apparatus for exercising an eyeball includes a plurality of gaze guide plates, in which the gaze guide plates are arranged on left and right sides of user's eyes, respectively, and a distance between the left gaze guide plate and the right gaze guide plate is adjusted in consideration of a distance between the user's eyeball and the gaze guide plate. The apparatus for exercising an eyeball further includes a gaze guide plate arranged at the same height as the user's eyes and a gaze guide plate arranged at upper and lower portions, respectively, centered on the user's eyes, in which a distance between the upper gaze guide plate and the lower gaze guide plate is adjusted in consideration of a distance between the user's eyeball and the central gaze guide plate, the gaze guide plate is mounted on a stand, and a height of a stand prop may be adjusted so that the height of the arrangement may vary, a front of the gaze guide plate is equipped with an LED module, an operation of the LED module is controlled by a controller, and numbers are displayed on the front by the LED module, so it is possible to perform eyeball exercise by moving the eyeball in the order of numbers displayed by the LED module.

However, the apparatus for exercising an eyeball failed to link eyeball exercise with looking at a smartphone.

### DISCLOSURE

### Technical Problem

Therefore, the present invention provides an apparatus for exercising an eyeball that enables a user to exercise an eyeball while watching a screen of a smartphone rotating at a low speed by continuing to maintain the screen state of the smartphone attached to a magnet of a balance weight without changing the screen state of the smartphone attached to the magnet since the balance weight is mounted on a connecting shaft formed at a free end of an arm to enable relative rotation when the free end of the arm makes a circular motion at a low speed around an output shaft of the geared motor.

Another object of the present invention provides an apparatus for exercising an eyeball capable of exercising an eyeball not only in a rotating direction but also in up and down, left and right, and oblique directions while watching a screen of a smartphone by allowing a smartphone to move not only in a rotating direction but also in left and right, up and down, and oblique directions.

### Technical Solution

In an aspect in the present invention, there is provided an apparatus for exercising an eyeball, in which a geared motor is mounted on an upper end of a column of a stand, an output shaft of the geared motor is inserted into a hole formed at one end of a rotating arm, a connecting shaft is mounted on a free end of the rotating arm in parallel with the output shaft, the connecting shaft is inserted into an upper horizontal shaft hole of a balance weight through a bearing, a magnet is mounted on a front of the balance weight, and an iron plate attached to a case of a smartphone is attached to the magnet.

The geared motor may be capable of both forward rotation and reverse rotation, the output shaft may rotate at a low speed, and the output shaft may continuously rotate at a constant speed at a low speed or repeatedly rotate and stop at a predetermined angle.

In the balance weight, a bundle weight part may be formed at a lower portion of the upper horizontal shaft hole, the plurality of bearings may be mounted inside the upper horizontal shaft hole, and the connecting shaft of the rotating arm may be fitted into the bearing.

When the free end of the rotating arm may make a circular motion at a low speed around the output shaft of the geared motor in a state where the smartphone is attached to the magnet of the balance weight, since the connecting shaft of the rotating arm may be inserted into the upper horizontal shaft hole of the balance weight through the bearing and the balance weight may rotate relative to the connecting shaft according to an arrangement position of the connecting shaft by the bundle weight part and the balance weight may be always maintained in a state where the bundle weight part is erected to be arranged at the lower portion of the upper horizontal shaft hole, the attachment state of the smartphone attached to the magnet of the balance weight may be always maintained constant without being tilted regardless of a rotational motion of the rotating arm, so a user performs eyeball exercise while watching a screen of the smartphone rotating at a low speed.

In another aspect in the present invention, there is provided an apparatus for exercising an eyeball, in which a rotating shaft is rotatably fitted into a cantilever of a stand, a connecting end of a rotating arm is vertically connected to a front end of the rotating shaft so that a free end of the rotating arm rotates around the rotating shaft, a ball screw driven by a linear step motor and a transfer nut are mounted inside the rotating arm, one end of a connecting shaft is connected to the transfer nut, the other end of the connecting shaft is inserted into an upper horizontal shaft hole of a balance weight through a bearing, a magnet is mounted on a front of the balance weight, an iron plate attached to a case of a smartphone is attached to the magnet, a driven pulley is mounted on a rear end of the rotating shaft, a geared motor is arranged inside a pedestal of the stand, a drive pulley is mounted on an output shaft of the geared motor, the drive pulley and the driven pulley are connected by a belt, a fixing ring of an energizing means is mounted on a front end of the cantilever, a slip ring rotating relative to the fixed ring is coupled to the rotating arm, a contact terminal of the slip ring is connected to a connection part of the fixed ring so that power is supplied to the linear step motor through the energizing means, a controller and the geared motor are respectively arranged on the pedestal of the stand, and the controller is connected to the fixed ring of the energizing device and the geared motor through wires, respectively.

The smartphone may rotate at a low speed of 360° around the rotating shaft, and move left and right along the ball screw arranged on the rotating arm in a state where the rotating arm is horizontally arranged, and when the rotating arm is erected, move up and down along the ball screw arranged on the rotating arm, and when the rotating arm is arranged diagonally, move in a diagonal direction along the ball screw arranged on the rotating arm, so a user's eyeball may move along the smartphone.

A geared motor may be mounted on an upper end of a column of a stand, a rotating support may be mounted on an output shaft of the geared motor, a central portion of a box housing in a shape of a long rectangular parallelepiped may be mounted on the rotating support, a belt and pulley means may be arranged inside a box housing, a cutout part may be formed long in a longitudinal direction on either side surface of the box housing, a transfer support may be coupled to the belt, one end of a connecting shaft may be vertically attached to a center of a vertical support plate part of the transfer support, the connecting shaft may be inserted into an upper horizontal shaft hole of a balance weight through a bearing, a magnet may be mounted on a front of the balance weight, an iron plate attached to a case of a smartphone may be attached to the magnet, so a user's eyeball may rotate or move up and down and left and right along the smartphone while a user watches a screen of the smartphone.

One end of the box housing may be provided with a reduction motor for driving the belt and pulley means and the other end of the box housing may be provided with the balance weight, a battery socket may be arranged inside the balance weight, a battery installed in the battery socket may be used as a power supply for the reduction motor, first and second detection sensors may be mounted on the side surface on which the cutout part is formed, so the first and second detection sensors may detect the transfer support.

The transfer support may include a coupling plate part that is coupled to the belt, a vertical part that is erected vertically in a center of the coupling plate part, an upper horizontal part that is bent at an upper end of the vertical part, the vertical support plate part that is bent downward from the upper horizontal part, and the connecting shaft, one end of which is vertically attached to a center of the vertical support plate part.

In the balance weight, a bunch weight part may be formed at a lower portion of the upper horizontal shaft hole, the plurality of bearings may be mounted inside the upper horizontal shaft hole, the connecting shaft may be inserted into the bearing, and the magnet may be attached to the front.

The smartphone may make a circular motion at a low speed around the output shaft of the geared motor, move left and right by the belt and pulley means and the transfer support in a state where the box housing is horizontally arranged, move up and down by the belt and pulley means and the transfer support while the box housing is erected, move in a diagonal direction by the belt and pulley means and the transfer support in a state where the box housing is arranged diagonally, so a user's eyeball may move along the smartphone.

A geared motor may be mounted on an upper end of a column of a stand, an output shaft of the geared motor may be connected to a shaft connection part formed in a center of a lower surface of a box housing, a rack and a pinion may be arranged inside the box housing, the pinion may be driven by a step motor, a battery case is mounted on the step motor to apply power from a battery in the battery case to the step motor, a cutout part may be formed long in the longitudinal direction on the side surface of the box housing, a shaft of the step motor may protrude outward from the pinion and the cutout part of the box housing, the shaft of the step motor may be inserted into the upper horizontal shaft hole of the balance weight through a bearing, a magnet may be mounted on the front of the balance weight, and an iron plate attached to a case of a smartphone may be attached to the magnet, so the user's eyeball may rotate along the smartphone or move along the cutout part of the box housing while the user watches a screen of the smartphone.

In the balance weight, a bunch weight part may be formed at the lower portion of the upper horizontal shaft hole, the plurality of bearings may be mounted inside the upper horizontal shaft hole, the shaft may be inserted into the bearing, and the magnet may be attached to the front.

### Advantageous Effects

As a result, according to the apparatus for exercising an eyeball of the present invention, it is possible to allow a user to exercise an eyeball not only in a rotating direction but also in up-down, left-right, and oblique directions, following the movement of the smartphone while watching a screen of a smartphone.

### BRIEF DESCRIPTION OF THE DRAWINGS

FIG. 1 is a side view illustrating an apparatus for exercising an eyeball according to a first embodiment of the present invention.

FIG. 2 is a front view illustrating the apparatus for exercising an eyeball according to the first embodiment of the present invention.

FIG. 3 is an exploded perspective view illustrating a rotating arm of the apparatus for exercising an eyeball according to the first embodiment of the present invention.

FIG. 4 is a side cross-sectional view illustrating an apparatus for exercising an eyeball according to a second embodiment of the present invention.

FIGS. 5 to 8 are front views for describing an operation of the apparatus for exercising an eyeball according to the second embodiment of the present invention.

FIG. 9 is a side view illustrating an apparatus for exercising an eyeball according to a third embodiment of the present invention.

FIG. 10 is an exploded perspective view illustrating an example in which a support is mounted on a belt apparatus for attaching a smartphone.

FIGS. 11 to 14 are front views for describing an operation of the apparatus for exercising an eyeball according to the third embodiment of the present invention.

FIG. 15 is a side view illustrating an apparatus for exercising an eyeball according to a fourth embodiment of the present invention.

FIG. 16 is an exploded perspective view illustrating that a rack and a pinion are mounted on a box housing and a balance weight is coupled to a shaft of a step motor for attaching a smartphone.

### BEST MODE

Hereinafter, embodiments of the present invention will be described in detail with reference to the accompanying drawings.

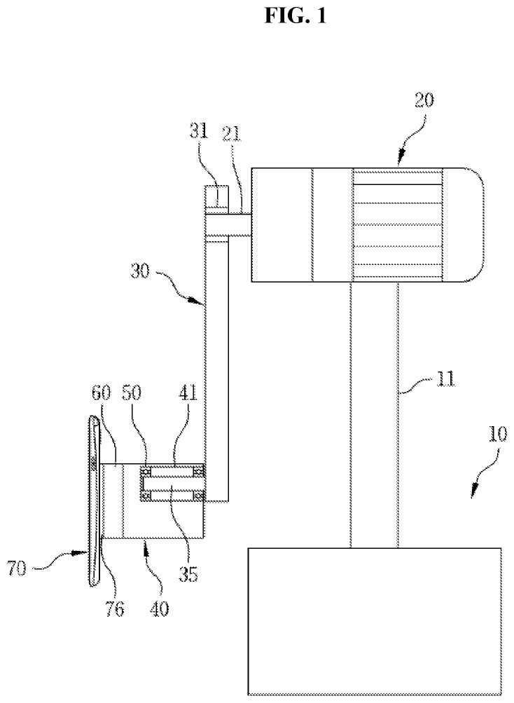

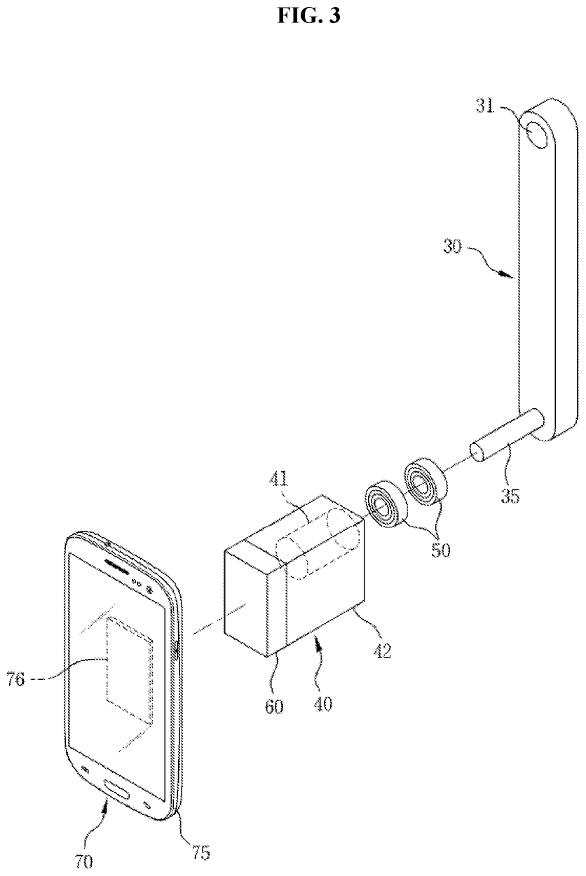

Referring to FIGS. 1 to 3, in an apparatus for exercising an eyeball according to a first embodiment of the present invention, a geared motor 20 is mounted on an upper end of a column 11 of a stand 10, an output shaft 21 of the geared motor 20 is inserted into a hole 31 formed at one end of the rotating arm 30, a connecting shaft 35 is mounted on a free end of the rotating arm 30 in parallel with the output shaft 21, the connecting shaft 35 is inserted into an upper horizontal shaft hole 41 of a balance weight 40 through a bearing 50, a magnet 60 is mounted on a front of the balance weight 40, and an iron plate 76 attached to a case 75 of a smartphone 70 is attached to the magnet 60.

The geared motor 20 is capable of both forward rotation and reverse rotation, the output shaft 21 may rotate at a low speed, and the output shaft may continue to rotate at a constant speed at a low speed or repeatedly rotate and stop at a predetermined angle.

In the balance weight 40, a bundle weight part 42 is formed at a lower portion of the upper horizontal shaft hole 41, a plurality of bearings 50 are mounted inside the upper horizontal shaft hole 41, and the connecting shaft 35 of the rotating arm 30 is fitted into the bearing 50.

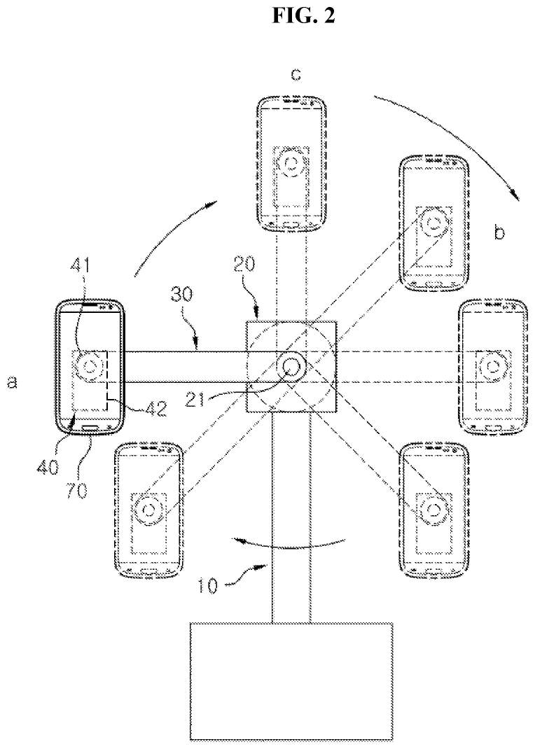

In the apparatus for exercising an eyeball according to a first embodiment of the present invention configured as described above, as illustrated in FIG. 2, when the free end of the rotating arm 30 makes a circular motion at a low speed around the output shaft 21 of the geared motor 20 in a state where the smartphone 70 is attached to the magnet 60 of the balance weight 40, the connecting shaft 35 of the rotating arm 30 is inserted into the upper horizontal shaft hole 41 of the balance weight 40 through the bearing 50 and the balance weight 40 rotates relative to the connecting shaft 35 according to an arrangement position of the connecting shaft 35 by the bundle weight part 42, so the balance weight 40 is always maintained in a state where the bundle weight part 42 is erected to be arranged at the lower portion of the upper horizontal shaft hole 41.

As a result, the attachment state of the smartphone attached to the magnet 60 of the balance weight 40 is always maintained constant without being tilted regardless of a rotational motion of the rotating arm 30.

That is, when the free end of the rotating arm 30 makes a circular motion at a low speed around the output shaft 21 of the geared motor 20, the state where the smartphone 70 is attached to the magnet 60 continues to be maintained as it is without changing the screen state of the smartphone 70 attached to the magnet 60 of the balance weight 40, so a user enables the eyeball exercise while watching the screen of the smartphone 70 rotating at a low speed.

For example, in a state where the smartphone 70 is mounted on the magnet 40 while being erected at position a in FIG. 2, even when the rotating arm 30 rotates 90° at a low speed around the output shaft 21 of the geared motor 20 and is arranged at position b, the balance weight 40 continues to maintain the smartphone 70 in the erected state, and even when the rotating arm 30 further rotates 45° at a low speed around the output shaft 21 of the geared motor 20 and is arranged at position c, the balance weight 40 continues to maintain the smartphone 70 in the erected state.

As described above, in the apparatus for exercising an eyeball according to the present invention, one attached to the magnet is referred to as a smartphone, but the present invention is not limited thereto, and may be an instruction board, a video device, or the like for eyeball exercise. It will be appreciated that attaching the instruction board or the video device for the eyeball exercise to the magnet instead of the smartphone also falls within the scope of the present invention.

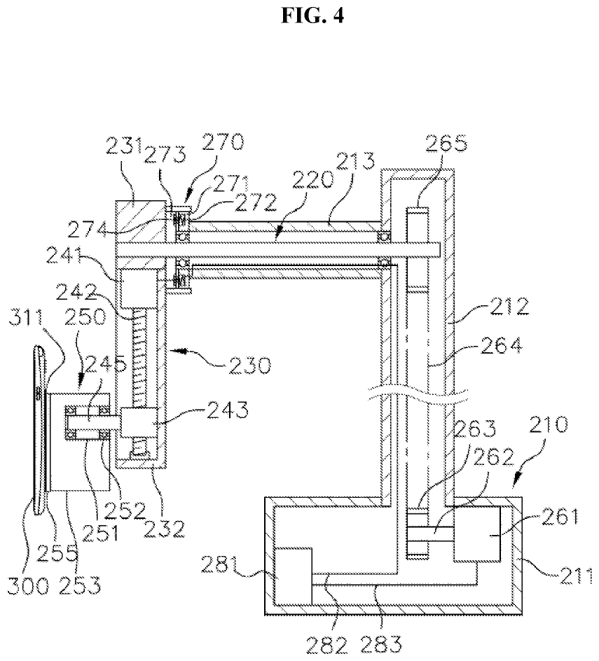

Referring to FIGS. 4 to 6, in an apparatus for exercising an eyeball according to a second embodiment of the present invention, a rotating shaft 220 is rotatably fitted into a cantilever 213 of a stand 210, a connecting end 231 of a rotating arm 230 is vertically connected to a front end of the rotating shaft 220 so that a free end 232 of the rotating arm 230 rotates around the rotating shaft 220, a ball screw 242 driven by a linear step motor 241 and a transfer nut 243 are mounted inside the rotating arm 230, one end of a connecting shaft 245 is connected to the transfer nut 243, the other end of the connecting shaft 245 is inserted into an upper horizontal shaft hole 251 of a balance weight 250 through a bearing 252, a magnet 255 is mounted on a front of the balance weight 250, an iron plate 311 attached to a case of a smartphone 300 is attached to the magnet 255.

In the apparatus for exercising an eyeball according to the second embodiment of the present invention, a driven pulley 265 is mounted on a rear end of the rotating shaft 220, a geared motor 261 is arranged inside a pedestal 211 of the stand 210, a drive pulley 263 is mounted on an output shaft 262 of the geared motor 261, the drive pulley 263 and the driven pulley 265 are connected by a belt 264, a fixing ring 271 of an energizing means 270 is mounted on a front end of the cantilever 213, a slip ring 273 rotating relative to a fixed ring 271 is coupled to the rotating arm 230, a contact terminal 274 of the slip ring 273 is connected to a connection part 272 of the fixed ring 271 so that power is supplied to the linear step motor 241 through the energizing means 270.

In addition, in the apparatus for exercising an eyeball according to the second embodiment of the present invention, a controller 281 and the geared motor 261 are respectively arranged on the pedestal 211 of the stand 210, and the controller 281 is connected to the fixed ring 271 of the power supply 270 and the geared motor 261 through wires 282 and 283, respectively.

The geared motor 261 is capable of both forward rotation and reverse rotation, the output shaft 21 may rotate at a low speed, and the output shaft continues to rotate at a constant speed at a low speed or repeatedly rotates and stops at a predetermined angle.

In the balance weight 250, a bundle weight part 253 is formed at a lower portion of the upper horizontal shaft hole 251, a plurality of bearings 252 are mounted inside the upper horizontal shaft hole 251, and the connecting shaft 245 is fitted into the bearing 252.

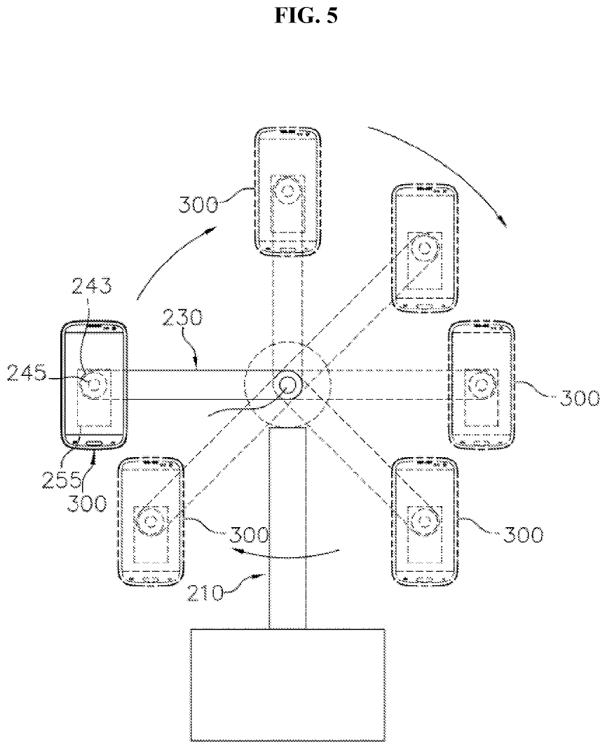

In the apparatus for exercising an eyeball according to the second embodiment of the present invention configured as described above, the power of the geared motor 261 is transmitted to the rotating shaft 220 through the pulleys 263 and 265 and the belt 264, and the free end 232 of the rotating arm 230 rotates around the rotating shaft 220 by the rotation of the rotating shaft 220, so, as illustrated in FIG. 5, the smartphone 300 arranged at the free end of the rotating arm 230 rotates 360° at a low speed around the rotating shaft 220.

In this case, since the connecting shaft 245 arranged at the free end of the rotating arm 230 is inserted into the upper horizontal shaft hole 251 of the balance weight 250 through the bearing 252, the balance weight 250 rotates relative to the connecting shaft 245 according to the arrangement position of the connecting shaft 245 by the bundle weight part 253, so the balance weight 250 is always maintained in the erected state so that the bundle weight part 253 is arranged at the lower portion of the upper horizontal shaft hole 251.

As a result, the attachment state of the smartphone 300 attached to the magnet 255 of the balance weight 250 is always maintained constant without being tilted regardless of a rotational motion of the rotating arm 230.

That is, when the free end of the rotating arm 230 makes a circular motion at a low speed around the rotating shaft 220, the state where the smartphone 300 is attached to the magnet 60 continues to be maintained as it is without changing the screen state of the smartphone 300 attached to the magnet 255 of the balance weight 250, so a user enables the eyeball exercise while watching the screen of the smartphone 300 rotating at a low speed.

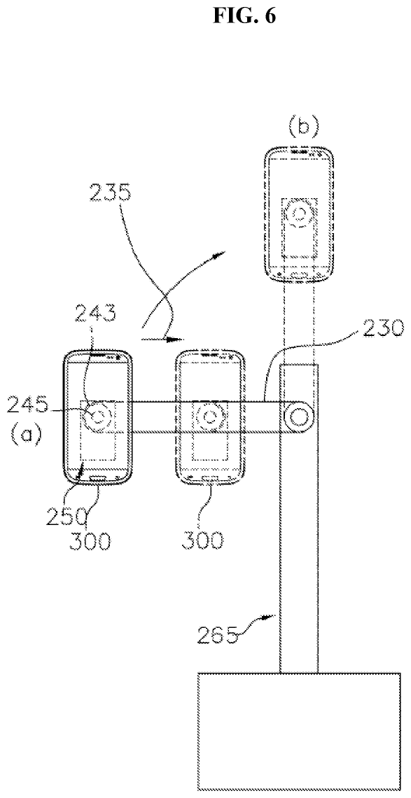

Although the rotating arm 230 rotates around the rotating shaft 220, power may be supplied to the linear step motor 241 through the energizing means 270, and as illustrated in FIG. 6, when the rotating arm 230 is arranged at horizontal position a to the left, the ball screw 242 rotates forward by the linear step motor 241, and thus, the transfer nut 243 moves along the ball screw 242 to the inside of the rotating arm 230 in a direction of an arrow 235, so the smartphone 300 moves from left to right, and the user's eyeball moves from left to right. Thereafter, the ball screw 242 rotates reversely by the linear step motor 241, and thus, the transfer nut 243 moves along the ball screw 242 from the inside to the outside of the rotating arm in the opposite direction of the arrow 235, so the smartphone 300 moves from the right to the left and the user's eyeball moves from the right to the left along the smartphone 300.

Thereafter, the rotating arm 230 rotates 90° around the rotating shaft 220, so the rotating arm 230 is erected and the smartphone 300 is arranged at the upper end of the rotating arm 230 which is position b.

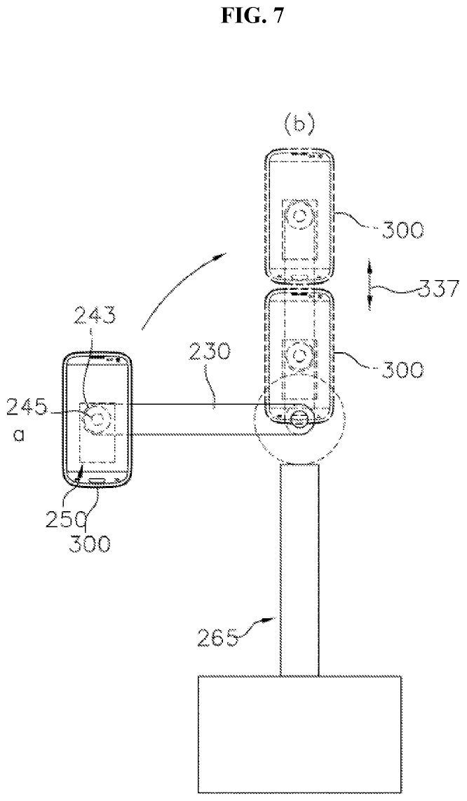

Thereafter, as illustrated in FIG. 7, in a state in which the rotating arm 230 is erected, the smartphone 300 may move up and down in a direction of an arrow 337 by the linear step motor 241, the ball screw 242, and the transfer nut 243, so that the user's eyeball may move up and down along the smartphone 300.

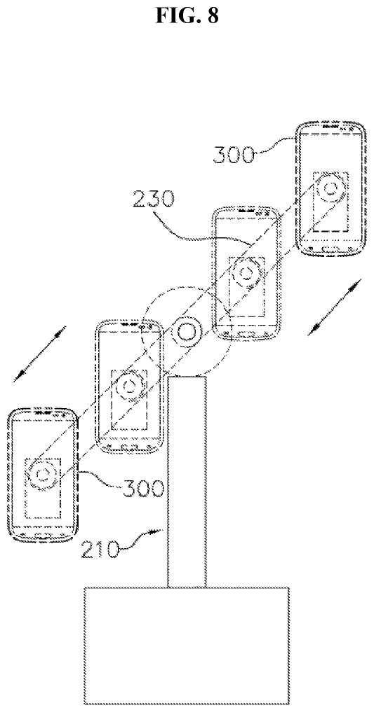

Furthermore, as illustrated in FIG. 8, in a state in which the rotating arm 230 angularly rotates by a predetermined angle e.g., any one of 30, 45, or 60° other than a right angle, the smartphone 300 may move in a diagonal direction by the linear step motor 241, the ball screw 242, and the transfer nut 243, so the user's eyeball moves along the smartphone 300 in a diagonal direction.

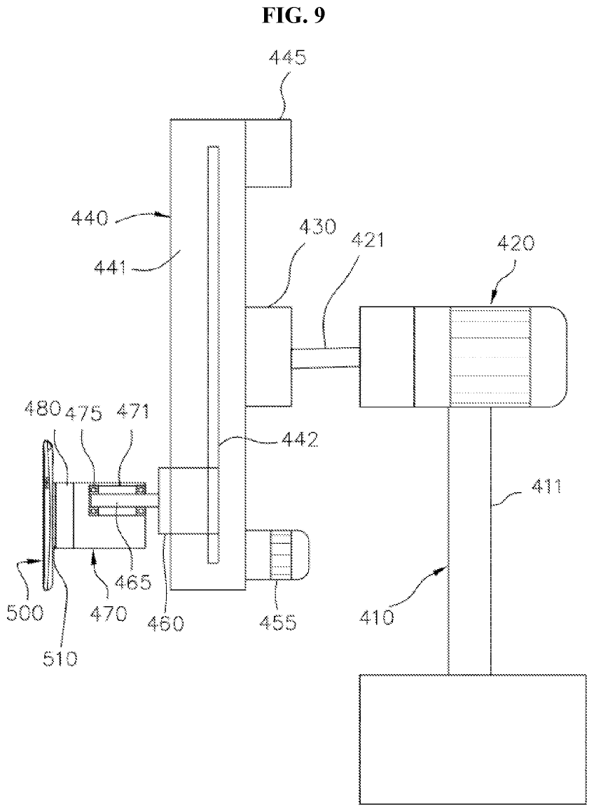

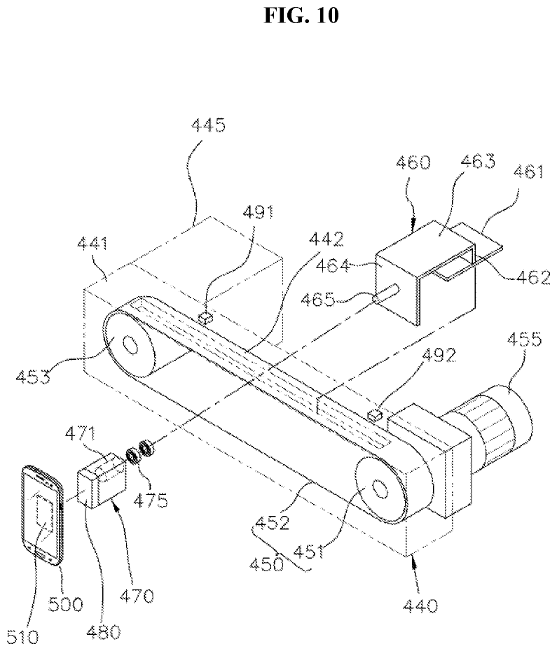

Referring to FIGS. 9 and 10, in an apparatus for exercising an eyeball according to a third embodiment of the present invention, a geared motor 420 is mounted on an upper end of a column 411 of a stand 410, a rotating support 430 is mounted on an output shaft 421 of a geared motor 420, a central portion of a box housing 440 in a shape of a long rectangular parallelepiped is mounted on the rotating support 430, a belt and pulley means 450 are arranged inside a box housing 440, a cutout part 442 is formed long in a longitudinal direction on either side surface 441 of the box housing 440, a transfer support 460 is coupled to a belt 452, one end of a connecting shaft 465 is vertically attached to a center of a vertical support plate part 464 of the transfer support 460, the connecting shaft 465 is inserted into an upper horizontal shaft hole 471 of a balance weight 470 through a bearing 475, a magnet 480 is mounted on a front of the balance weight 470, an iron plate 510 attached to a case of a smartphone 500 is attached to the magnet 480, so a user's eyeball rotates or moves left and right along the smartphone while the user watches the screen of the smartphone 500.

The geared motor 420 is capable of both forward rotation and reverse rotation, the output shaft 21 may rotate at a low speed, and the output shaft continues to rotate at a constant speed at a low speed or repeatedly rotates and stops at a predetermined angle.

One end of the box housing 440 is provided with a reduction motor 455 for driving the belt and pulley means 450 and the other end of the box housing 440 is provided with a balance weight 445, a battery socket not illustrated is arranged inside the balance weight 445, a battery not illustrated installed in the battery socket is used as a power supply for the reduction motor 455, first and second detection sensors 491 and 492 are mounted on the side surface 441 on which the cutout part 442 is formed, so the first and second detection sensors 491 and 492 detect the transfer support 460.

The first and second detection sensors 491 and 492 are any one of a proximity sensor, a limit switch, and a touch sensor.

In the belt and pulley means 450, a driving pulley 451 and a driven pulley 453 are arranged at one end and the other end of a box housing 440, respectively, the belt 452 is hung on the driving pulley 451 and the driven pulley 453, and the drive pulley 451 is driven by the reduction motor 455, so the belt moves left and right between the drive pulley 451 and the driven pulley.

The transfer support 460 includes a coupling plate part 461 that is coupled to the belt 452, a vertical part 462 that is erected vertically in a center of the coupling plate part 461, an upper horizontal part 463 that is bent at an upper end of the vertical part 462, the vertical support plate part 464 that is bent downward from the upper horizontal part 463, and the connecting shaft 465, one end of which is vertically attached to a center of the vertical support plate part 464.

In the balance weight 470, a bunch weight part 472 is formed at a lower portion of the upper horizontal shaft hole 471, a plurality of bearings 475 are mounted inside the upper horizontal shaft hole 471, the connecting shaft 465 is inserted into the bearing 475, and the magnet 480 is attached to the front.

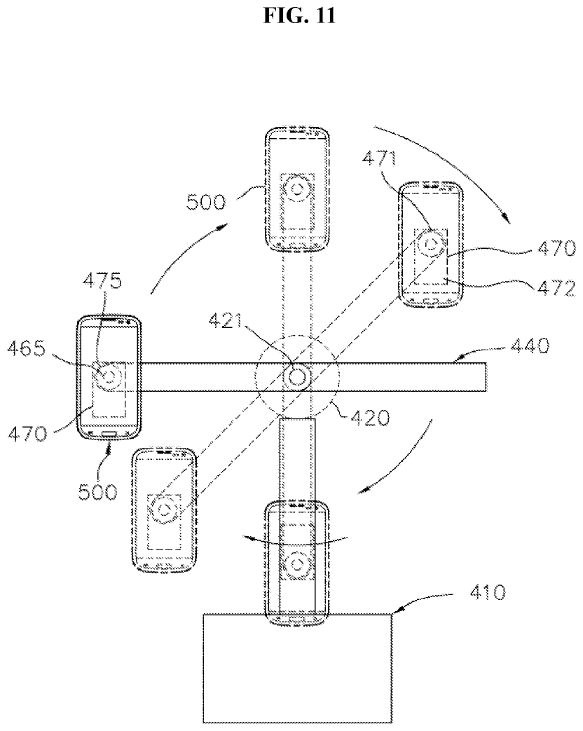

In the apparatus for exercising an eyeball according to the third embodiment of the present invention configured as described above, as illustrated in FIG. 11, when both end portions of the box housing 440 makes a circular motion at a low speed around the output shaft 421 of the geared motor 420, the connecting shaft 465 of the transfer support 460 is inserted into the upper horizontal shaft hole 471 of the balance weight 470 through the bearing 475, the balance weight 470 rotates relative to the connecting shaft 465 according to an arrangement position of the connecting shaft 465 by the bundle weight part 472, so the balance weight 470 is always maintained in a state where the bundle weight part 472 is erected to be arranged at the lower portion of the upper horizontal shaft hole 471.

As a result, the attachment state of the smartphone 500 attached to the magnet 480 of the balance weight 470 is always maintained constant without being tilted regardless of a rotational motion of the box housing 440. That is, the screen state of the smartphone 500 attached to the magnet 480 of the balance weight 470 does not change and the state where the smartphone 500 is attached to the magnet 480 continues to be maintained as it is, so the user may make eyeball exercise while watching the screen of the smartphone 500 rotating at a low speed.

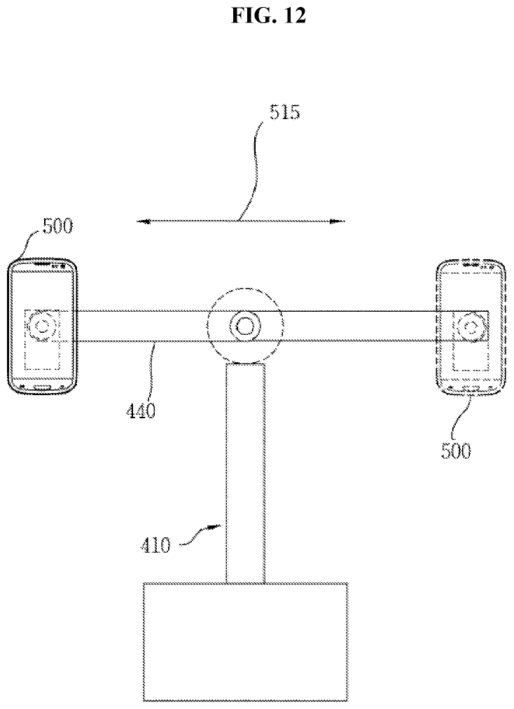

As illustrated in FIG. 12, in a state where the box housing 440 is horizontally arranged, the power of the reduction motor 455 is transmitted to the drive pulley 451, and thus, the transfer support 460 mounted on the belt 452 moves left and right slowly from left to right and from right to left between the first detection sensor 491 and the second detection sensor 492, so the user's eyeball moves left and right along the smartphone 500 in a direction of an arrow 515 to exercise while the user looks at the screen of the smartphone 500 mounted on the transfer support 460.

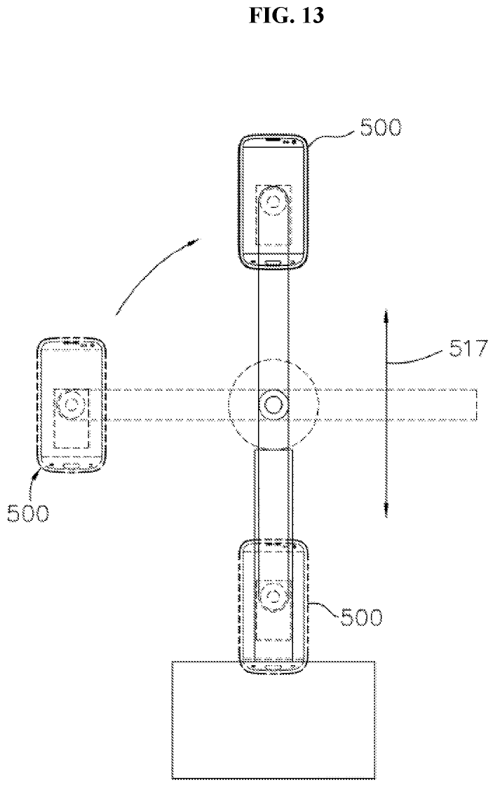

Thereafter, as illustrated in FIG. 13, when the box housing 440 rotates 90°, the box housing 440 is erected, and the smartphone 500 is arranged at the upper end of the box housing 440 which is position b.

Thereafter, in the state where the box housing 440 is erected, the smartphone 500 may move up and down in a direction of an arrow 517 by the belt and pulley means 470 as described above, so the user's eyeball may move up and down along the smartphone 500.

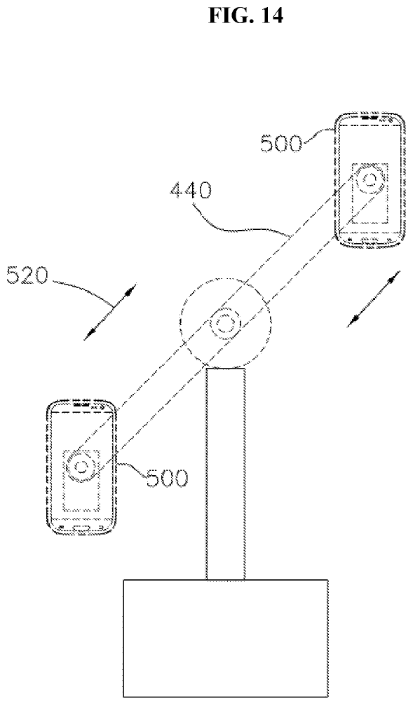

Furthermore, as illustrated in FIG. 14, in the state in which the box housing 440 angularly rotates by a predetermined angle e.g., any one of 30, 45, or 60° other than a right angle, the smartphone 500 may move in a diagonal direction as shown in an arrow 520 by the belt and pulley means 470, the ball screw 242, so the user's eyeball moves along the smartphone 300 in a diagonal direction.

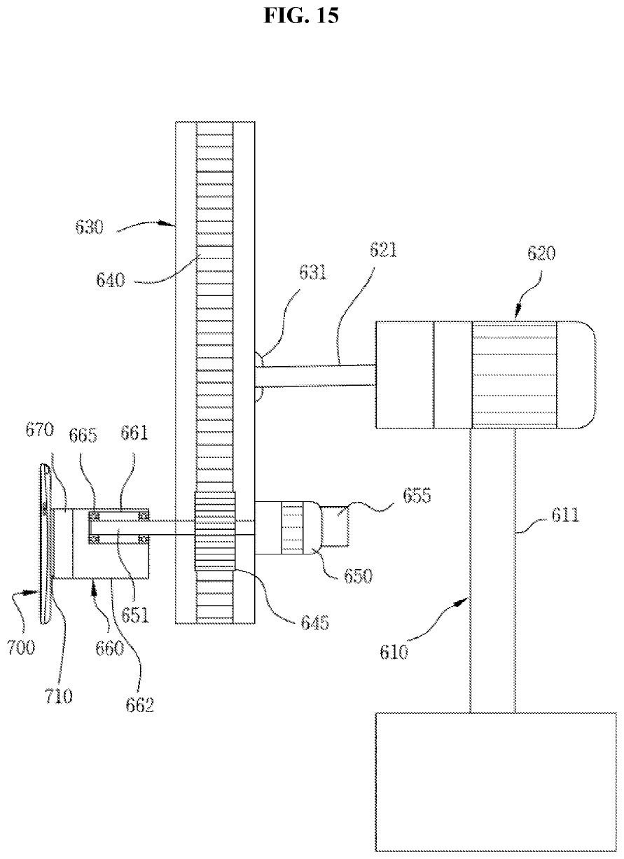

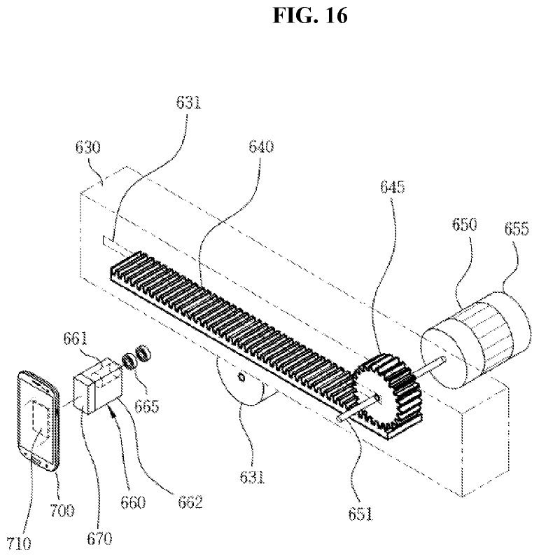

Referring to FIGS. 15 and 16, in an apparatus for exercising an eyeball according to a fourth embodiment of the present invention, a geared motor 620 is mounted on an upper end of a column 611 of a stand 610, an output shaft 621 of the geared motor 620 is connected to a shaft connection part 622 formed in a center of a lower surface of a box housing 630, a rack 640 and a pinion 645 are arranged inside the box housing 630, the pinion 645 is driven by a step motor 650, a battery case 655 is mounted on the step motor 650 to apply power from the battery in the battery case 655 to the step motor 650, a cutout part 631 is formed long in the longitudinal direction on the side surface of the box housing 630, a shaft 651 of the step motor 650 protrudes outward from the pinion 645 and the cutout part 631 of the box housing 630, the shaft 651 of the step motor 650 is inserted into the upper horizontal shaft hole 661 of the balance weight 660 through the bearing 665, a magnet 670 is mounted on the front of the balance weight 660, and an iron plate 710 attached to a case of a smartphone 700 is attached to the magnet 670, so the user's eyeball rotates along the smartphone 700 or moves along the cutout part 631 of the box housing 630 while the user watches the screen of the smartphone 700.

In the balance weight 660, a bunch weight part 662 is formed at the lower portion of the upper horizontal shaft hole 662, the plurality of bearings 665 are mounted inside the upper horizontal shaft hole 661, the shaft 651 is inserted into the bearing 665, and the magnet 670 is attached to the front.

As described with reference to FIGS. 11 to 14 in the apparatus for exercising an eyeball according to the third embodiment of the present invention, in the apparatus for exercising an eyeball according to the fourth embodiment of the present invention configured as described above, the smartphone 500 makes a circular motion at a low speed around the output shaft 621 of the geared motor 620, and the box housing 440 slowly moves left and right, up and down, and diagonally by the rack 640 and the pinion 645 in a state in which the box housing 440 is arranged horizontally, vertically, or obliquely, so the user's eyeball rotates and moves left and right, up and down, and diagonally moves along the smartphone 500 while the user watches the screen of the smartphone 500.

[Description of reference numerals]

| | |
|---|---|
| 10: Stand | 20: Geared motor |
| 30: Rotating arm | 40: Balance weight |
| 50: Bearing | 60 : Magnet |
| 70: Smartphone | |

1. An apparatus for exercising an eyeball, wherein a geared motor (20) is mounted on an upper end of a column (11) of a stand (10), an output shaft (21) of the geared motor (20) is inserted into a hole (31) formed at one end of a rotating arm (30), a connecting shaft (35) is mounted on a free end of the rotating arm (30) in parallel with the output shaft (21), the connecting shaft (35) is inserted into an upper horizontal shaft hole (41) of a balance weight (40) through a bearing (50), a magnet (60) is mounted on a front of the balance weight (40), and an iron plate (76) attached to a case (75) of a smartphone (70) is attached to the magnet (60).

2. The apparatus of claim 1, wherein the geared motor (20) is capable of both forward rotation and reverse rotation, the output shaft (21) rotates at a low speed, and the output shaft continues to rotate at a constant speed at a low speed or repeatedly rotates and stops at a predetermined angle.

3. The apparatus of claim 1, wherein, in the balance weight (40), a bundle weight part (42) is formed at a lower portion of the upper horizontal shaft hole (41), the plurality of bearings (50) are mounted inside the upper horizontal shaft hole (41), and the connecting shaft (35) of the rotating arm (30) is fitted into the bearing (50).

4. The apparatus of claim 1, wherein, when the free end of the rotating arm (30) makes a circular motion at a low speed around the output shaft (21) of the geared motor (20) in a state where the smartphone (70) is attached to the magnet (60) of the balance weight (40), since the connecting shaft (35) of the rotating arm (30) is inserted into the upper horizontal shaft hole (41) of the balance weight (40) through the bearing (50) and the balance weight (40) rotates relative to the connecting shaft (35) according to an arrangement position of the connecting shaft (35) by the bundle weight part (42) and the balance weight (40) is always maintained in a state where the bundle weight part (42) is erected to be arranged at the lower portion of the upper horizontal shaft hole (41), the attachment state of the smartphone (70) attached to the magnet (60) of the balance weight (40) is always maintained constant without being tilted regardless of a rotational motion of the rotating arm (30), so a user performs eyeball exercise while watching a screen of the smartphone (70) rotating at a low speed.

5. An apparatus for exercising an eyeball, wherein a rotating shaft (220) is rotatably fitted into a cantilever (213) of a stand (210), a connecting end (231) of a rotating arm (230) is vertically connected to a front end of the rotating shaft (220) so that a free end (232) of the rotating arm (230) rotates around the rotating shaft (220), a ball screw (242) driven by a linear step motor (241) and a transfer nut (243) are mounted inside the rotating arm (230), one end of a connecting shaft (245) is connected to the transfer nut (243), the other end of the connecting shaft (245) is inserted into an upper horizontal shaft hole (251) of a balance weight (250) through a bearing (252), a magnet (255) is mounted on a front of the balance weight (250), an iron plate (311) attached to a case of a smartphone (300) is attached to the magnet (255),
a driven pulley (265) is mounted on a rear end of the rotating shaft (220), a geared motor (261) is arranged inside a pedestal (211) of the stand (210), a drive pulley (263) is mounted on an output shaft (262) of the geared motor (261), the drive pulley (263) and the driven pulley (265) are connected by a belt (264), a fixing ring (271) of an energizing means (270) is mounted on a front end of the cantilever (213), a slip ring (273) rotating relative to the fixed ring (271) is coupled to the rotating arm (230), a contact terminal (274) of the slip ring (273) is connected to a connection part (272) of the fixed ring (271) so that power is supplied to the linear step motor (241) through the energizing means (270),
a controller (281) and the geared motor (261) are respectively arranged on the pedestal (211) of the stand (210), and the controller (281) is connected to the fixed ring (271) of the power supply (270) and the geared motor (261) through wires (282 and 283), respectively.

6. The apparatus of claim 5, wherein the smartphone (300) rotates at a low speed of 360° around the rotating shaft (220), and moves left and right along the ball screw (242) arranged on the rotating arm (230) in a state where the rotating arm (230) is horizontally arranged, and when the rotating arm (230) is erected, moves up and down along the ball screw (242) arranged on the rotating arm (230), and when the rotating arm (230) is arranged diagonally, moves in a diagonal direction along the ball screw (242) arranged on the rotating arm (230), so a user's eyeball moves along the smartphone (300).

7. An apparatus for exercising an eyeball, wherein a geared motor (420) is mounted on an upper end of a column (411) of a stand (410), a rotating support (430) is mounted on an output shaft (421) of the geared motor (420), a central portion of a box housing (440) in a shape of a long rectangular parallelepiped is mounted on the rotating support (430), a belt and pulley means (450) are arranged inside a box housing (440), a cutout part (442) is formed long in a longitudinal direction on either side surface (441) of the box housing (440), a transfer support (460) is coupled to the belt (452), one end of a connecting shaft (465) is vertically attached to a center of a vertical support plate part (464) of the transfer support (460), the connecting shaft (465) is inserted into an upper horizontal shaft hole (471) of a balance weight (470) through a bearing (475), a magnet (480) is mounted on a front of the balance weight (470), an iron plate (510) attached to a case of a smartphone (500) is attached to the magnet (480), so a user's eyeball rotates or moves up and down and left and right along the smartphone while a user watches a screen of the smartphone (500).

8. The apparatus of claim 7, wherein one end of the box housing (440) is provided with a reduction motor (455) for driving the belt and pulley means (450) and the other end of the box housing (440) is provided with the balance weight (445), a battery socket is arranged inside the balance weight (445), a battery installed in the battery socket is used as a power supply for the reduction motor (455), first and second detection sensors (491 and 492) are mounted on the side surface (441) on which the cutout part (442) is formed, so the first and second detection sensors (491 and 492) detect the transfer support (460).

9. The apparatus of claim 7, wherein the transfer support (460) includes a coupling plate part (461) that is coupled to the belt (452), a vertical part (462) that is erected vertically in a center of the coupling plate part (461), an upper horizontal part (463) that is bent at an upper end of the vertical part (462), the vertical support plate part (464) that is bent downward from the upper horizontal part (463), and the connecting shaft (465), one end of which is vertically attached to a center of the vertical support plate part (464).

10. The apparatus of claim 7, wherein, in the balance weight (470), a bunch weight part (472) is formed at a lower portion of the upper horizontal shaft hole (471), the plurality of bearings (475) are mounted inside the upper horizontal shaft hole (471), the connecting shaft (465) is inserted into the bearing (475), and the magnet (480) is attached to the front.

11. The apparatus of claim 7, wherein the smartphone (500) makes a circular motion at a low speed around the output shaft (421) of the geared motor (420), moves left and right by the belt and pulley means (450) and the transfer support (460) in a state where the box housing (440) is horizontally arranged, moves up and down by the belt and pulley means (450) and the transfer support (460) while the box housing (440) is erected, moves in a diagonal direction by the belt and pulley means (450) and the transfer support (460) in a state where the box housing (440) is arranged diagonally, so a user's eyeball moves along the smartphone (500).

12. An apparatus for exercising an eyeball, wherein a geared motor (620) is mounted on an upper end of a column (611) of a stand (610), an output shaft (621) of the geared motor (620) is connected to a shaft connection part (622) formed in a center of a lower surface of a box housing (630), a rack (640) and a pinion (645) are arranged inside the box housing (630), the pinion (645) is driven by a step motor (650), a battery case (655) is mounted on the step motor 650 to apply power from a battery in the battery case (655) to the step motor (650), a cutout part (631) is formed long in the longitudinal direction on the side surface of the box housing (630), a shaft (651) of the step motor (650) protrudes outward from the pinion (645) and the cutout part (631) of the box housing (630), the shaft (651) of the step motor (650) is inserted into the upper horizontal shaft hole (661) of the balance weight (660) through a bearing (665), a magnet (670) is mounted on the front of the balance weight (660), and an iron plate (710) attached to a case of a smartphone (700) is attached to the magnet (670), so the user's eyeball rotates along the smartphone (700) or moves along the cutout part (631) of the box housing (630) while the user watches a screen of the smartphone (700).

13. The apparatus of claim 12, wherein in the balance weight (660), a bunch weight part (662) is formed at the lower portion of the upper horizontal shaft hole (662), the plurality of bearings (665) are mounted inside the upper horizontal shaft hole (661), the shaft (651) is inserted into the bearing (665), and the magnet (670) is attached to the front.
